(19) United States
(12) Patent Application Publication
(10) Pub. No.: US 2024/0346929 A1
(43) Pub. Date: Oct. 17, 2024

(54) VEHICLE INTERACTION SYSTEM

(71) Applicant: Hailo Solutions Pty Ltd, Kelvin Grove, Queensland (AU)

(72) Inventors: Santiago VELASQUEZ HURTADO, Kelvin Grove (AU); Jonathan Mark DALTON, Kelvin Grove (AU)

(21) Appl. No.: 18/683,710

(22) PCT Filed: Jul. 28, 2022
(86) PCT No.: PCT/AU22/50798

§ 371 Date: Feb. 14, 2024

(30) Foreign Application Priority Data
Aug. 26, 2021 (AU) 2021902786

(51) Int. Cl. G08G 1/133; G01C 21/34; G01C 21/36

(52) U.S. Cl. CPC G08G 1/133; G01C 21/343; G01C 21/3602

(57) ABSTRACT

A vehicle interaction system to allow passenger interaction with a public transport vehicle, the system including a processing system, a passenger client device configured to: determine a selected vehicle stop in accordance with user input commands; provide a selected vehicle stop to the processing system; and, notify the passenger when the vehicle is approaching the selected vehicle stop and a vehicle terminal configured to: receive a selected vehicle stop notification from the processing system; determine when the vehicle is approaching the selected stop by monitoring a current vehicle location; and, in response to a positive determination, selectively controlling at least part of the operation of the vehicle and/or alert the driver.

### BACKGROUND OF THE INVENTION

The present invention relates to a vehicle interaction system and method for allowing passenger interaction with a public transport vehicle, such as a bus, train or ferry. In one specific example, the vehicle interaction system is intended to facilitate impaired passenger interaction with a public transport vehicle, such as boarding, riding and/or departing a vehicle.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

Public transport (also known as public transportation, public transit, mass transit, or simply transit) is a system of transport for passengers by group travel systems available for use by the general public unlike private transport, typically managed on a schedule, operated on established routes, and that typically charge a posted fee for each trip.

Unlike transport schemes, such as ride sharing or similar, to use public transport a passenger must present at a stop or station (referred to hereafter as a stop), and board the vehicle on which they intend to travel, which can present challenges for impaired people.

For example, in many situations multiple different routes will use a common stop, and so a passenger presenting at a stop must select the correct vehicle on which to travel, and in the case of buses, this often involves hailing the vehicle so that the vehicle stops. However, in the case of visually impaired passengers, the passenger is unable to view details of vehicles approaching meaning they are unable to hail the desired vehicle. Similarly, when it comes to departing a vehicle, a visually impaired person might not be aware when a desired destination is reached.

Some transport systems provide information that can assist with this process. However, in these situations, it is up to the passenger to use the data streams pushed out by transport network operators to hopefully stand in the appropriate location, at the appropriate time, on a platform to not be left behind. This approach assumes the transport network provides real time information to passengers, and if they don't, the process becomes even more difficult. In addition, this also relies on the vehicle stopping at the identified location-which regularly does not occur, for example if multiple vehicles are present at a stop, or if a vehicle bypasses a stop if it is full. Even after boarding, a visually impaired passenger might have to rely on bus, train, tram, metro and or ferry operators' memory to let them know when they have arrived at their desired stop. This current approach does not incorporate the vehicle operators, and transport networks in an active way and it up to the passengers to navigate the systems, and hope that they get picked up, and dropped off at the desired locations. Alternatively, a user might rely on location tracking in-built within their smartphone or similar, but this is generally of only limited accuracy, and may not therefore accurately identify when a vehicle arrives at a stop. This can result in a passenger missing their stop, or attempting to leave the vehicle prior to it arriving at a stop.

For physically impaired people, there might be different challenges in boarding a vehicle, for example requiring that a vehicles suspension is lowered, a wheelchair ramp is deployed, or the like. Even if such operations are not required, it might take a physically impaired person longer to board or depart the vehicle than normal, or risk falling over if the vehicle accelerates too quickly which can be problematic.

Whilst the above issues might be alleviated to a degree if a physical driver is present, this isn't always the case. For example, a bus driver will not necessarily be aware of a person's impairment and may not therefore control the vehicle accordingly, whilst there is often no mechanism to control driverless vehicles, so for example doors on an automated vehicle may remain open for a set period of time, meaning it is not always feasible for a person to board or depart safely.

It should also be noted that issues are not isolated to people who have an impairment or disability, but the general public also experiences these problems.

U.S. Pat. No. 8,874,362 describes a method for determining the location of a vehicle using a GPS receiver and a predefinable coordinate system, in particular a city map, a map, a nautical chart or the like, comprises the following method steps: determination of the GPS coordinates by means of a GPS receiver or some other suitable method, for example Gallileo, beacon, etc., projection of the determined coordinates onto the coordinate system and correction of the GPS coordinates or the projected coordinates in the sense of compound navigation. A corresponding device is specified.

### SUMMARY OF THE PRESENT INVENTION

In one broad form, an aspect of the present invention seeks to provide a vehicle interaction system to allow passenger interaction with a public transport vehicle, the system including: a processing system: a passenger client device configured to: determine a selected vehicle stop in accordance with user input commands: provide a selected vehicle stop to the processing system; and, notify the passenger when the vehicle is approaching the selected vehicle stop; and, a vehicle terminal configured to: receive a selected vehicle stop notification from the processing system: determine when the vehicle is approaching the selected stop by monitoring a current vehicle location; and, in response to a positive determination, selectively control at least part of the operation of the vehicle.

In one broad form, an aspect of the present invention seeks to provide a vehicle interaction method to allow passenger interaction with a public transport vehicle, the method including: in a passenger client device: determining a selected vehicle stop in accordance with user input commands: providing a selected vehicle stop to a processing system; and, notifying the passenger when the vehicle is approaching the selected vehicle stop; and, in a vehicle terminal: receiving a selected vehicle stop notification from the processing system: determining when the vehicle is approaching the selected stop by monitoring a current vehicle location; and, in response to a positive determination, selectively controlling at least part of the operation of the vehicle.

In one broad form, an aspect of the present invention seeks to provide a vehicle interaction system to allow passenger interaction with a public transport vehicle, the system including: a processing system: a passenger client device configured to: determine a selected vehicle stop in accordance with user input commands: provide a selected vehicle stop to the processing system; and, notify the passenger when the vehicle is approaching the selected vehicle stop; and, a vehicle terminal configured to: receive a selected vehicle stop notification from the processing system: determine when the vehicle is approaching the selected stop by monitoring a current vehicle location; and, in response to a positive determination, generate an alert for a vehicle driver.

In one broad form, an aspect of the present invention seeks to provide a vehicle interaction method to allow passenger interaction with a public transport vehicle, the method including: in a passenger client device: determining a selected vehicle stop in accordance with user input commands: providing a selected vehicle stop to a processing system; and, notifying the passenger when the vehicle is approaching the selected vehicle stop; and, in a vehicle terminal: receiving a selected vehicle stop notification from the processing system; determining when the vehicle is approaching the selected stop by monitoring a current vehicle location; and, in response to a positive determination, generating an alert for a vehicle driver.

In one embodiment the vehicle terminal is configured to control at least one: a door opening duration, or opening/closing instruction to the door; a door opening location; a vehicle suspension height: a vehicle acceleration; a vehicle deceleration; a vehicle velocity: a vehicle stopping duration: a vehicle stopping location: vehicle lighting: vehicle camera: vehicle routing parameters; and, vehicle air conditioning.

In one embodiment the vehicle terminal is configured to: determine one or more passenger requirements; and at least partially control the vehicle in accordance with the passenger requirements.

In one embodiment the vehicle terminal is configured to determine the passenger requirements in accordance with a requirements indication from the processing system.

In one embodiment the passenger client device is configured to: obtain a list of available vehicle stops from the processing system: present the list of available vehicle stops to the passenger; and, determine a selected stop in accordance with user input commands.

In one embodiment the processing system is configured to: determine one or more passenger requirements; and, determine available vehicle stops at least in part using the one or more passenger requirements.

In one embodiment the processing system is configured to determine one or more passenger requirements based on at least one of: a passenger profile; and, an indication of passenger requirements received from the passenger client device.

In one embodiment the passenger client device is configured to: determine a passenger location; and, obtain a list of available vehicle stops from the processing system using the passenger location.

In one embodiment the processing system is configured to: receive a passenger location indication from the passenger client device; and, determine available vehicle stops at least in part using the passenger location.

In one embodiment the processing system is configured to: determine vehicle routing information; and, provide an indication of the vehicle routing information to the passenger client device.

In one embodiment the passenger client device is configured to: obtain vehicle routing information from the processing system: present vehicle routing information to the passenger; and, determine a selected vehicle route in accordance with user input commands.

In one embodiment the processing system is configured to: receive a selected vehicle route indication from the passenger client device; and, provide the selected vehicle stop notification to the vehicle terminal using the selected vehicle route indication.

In one embodiment the processing system is configured to: receive a selected vehicle route indication from the passenger client device; and, determine available vehicle stops at least in part using the selected vehicle route.

In one embodiment, in response to a positive determination, the vehicle terminal is configured to provide a vehicle approaching indication to at least one of: the processing system; and, the passenger client device.

In one embodiment the processing system is configured to: receive a vehicle approaching indication from the vehicle terminal when the vehicle is approaching a selected stop; and, provide a vehicle approaching notification to the passenger client device.

In one embodiment the vehicle terminal is configured to: determine if a passenger is or has completed boarding or departing the vehicle; and, in response to a positive boarding or departing determination, at least one of: generate an alert for a vehicle driver; and, selectively control at least part of the operation of the vehicle.

In one embodiment the passenger client device is configured to: determine if a passenger is or has completed boarding or departing in accordance with user input commands; and, provide a passenger boarding or departing notification to at least one of: the vehicle terminal; and, the processing system.

In one embodiment the system includes vehicle beacons and wherein the passenger client device is configured to communicate using the vehicle beacons with at least one of: the processing system; and, the vehicle terminal.

In one embodiment the selected stop is at least one of: a boarding stop; and, a destination stop.

In one embodiment the vehicle terminal is configured to control at least part of the operation of the vehicle by sending control instructions to a vehicle control system.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1 is a schematic diagram of an example of a vehicle interaction system:

FIG. 2 is a flow chart of an example of a method for use in interacting with a vehicle, for example for hailing and/or stopping a bus:

FIG. 3 is as schematic diagram of an example of a processing system;

FIG. 4 is a schematic diagram of an example of a client device:

FIG. 5 is a schematic diagram of an example of a vehicle terminal; and,

FIGS. 6A to 6D is a flow chart of a specific example of a method for use in interacting with a vehicle.

### DETAILED DESCRIPTION OF THE PREFERRED EMBODIMENTS

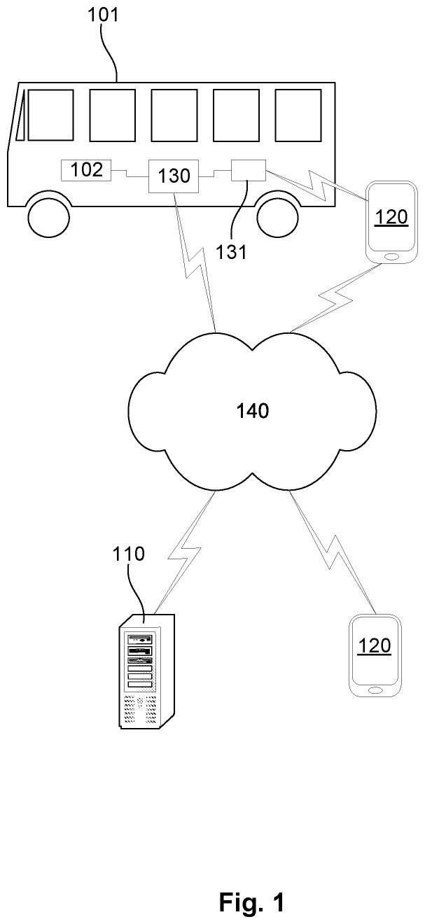

An example of a vehicle interaction system will now be described with reference to FIG. 1.

In this example, a vehicle 101 is provided as part of a public transport infrastructure. The vehicle can be of any appropriate form, such as a bus, train, trolleybus, tram, light rail, a ferry, a rapid transit such as a metro, subway or underground, or the like. However, it will be appreciated that this is not intended to be limiting, and the approaches described herein could be used with other vehicles.

The system includes a processing system 110, such as a computer server or similar, which is in communication with a passenger client device 120, and a vehicle terminal 130 installed on the vehicle 101, which may optionally be connected with one or more beacons 131 installed within the vehicle, as well as a vehicle control system 102.

The passenger client device 120 could be of any appropriate form, and could include a personal device, such as a tablet, smart phone, mobile phone, personal data assistant, computer system, laptop, or similar, or could be a standalone device, such as a touch screen kiosk, or similar, which may be provided at a specific venue such as a transport facility, hub or other stop.

The vehicle terminal 130 could be of any appropriate form, depending on the preferred implementation and could include a device, such as a tablet, smart phone, or the like mounted within the vehicle. Additionally and/or alternatively, the vehicle terminal could include custom hardware within the vehicle, and could for example be provided as a software module executed by the existing vehicle control system 102 and/or a ticketing system.

The optional beacons 131 are typically configured to communicate with onboard passenger client devices 120, either to allow the passenger client devices 120 to communicate directly with the vehicle terminal 130, or to allow communication with the processing systems 110 to be routed via the beacons and/or vehicle terminal 130, for example in the event that a passenger client device 120 losses connection to the processing system via other connections.

The processing system 110, passenger client device 120, and vehicle terminal 130, are typically in communication via one or more communications networks 140. It will be appreciated that any configuration of networks 140 can be used, and in practice the client devices 120, the processing system 110 and vehicle terminal 130 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The passenger client device 120 can also communicate with the beacons 131 using a short-range communication protocol, such as Bluetooth, BLE, or the like, to allow for onward connectivity to the vehicle terminal 130 and/or the processing systems 110, again via short range communications and/or via one or more communications networks.

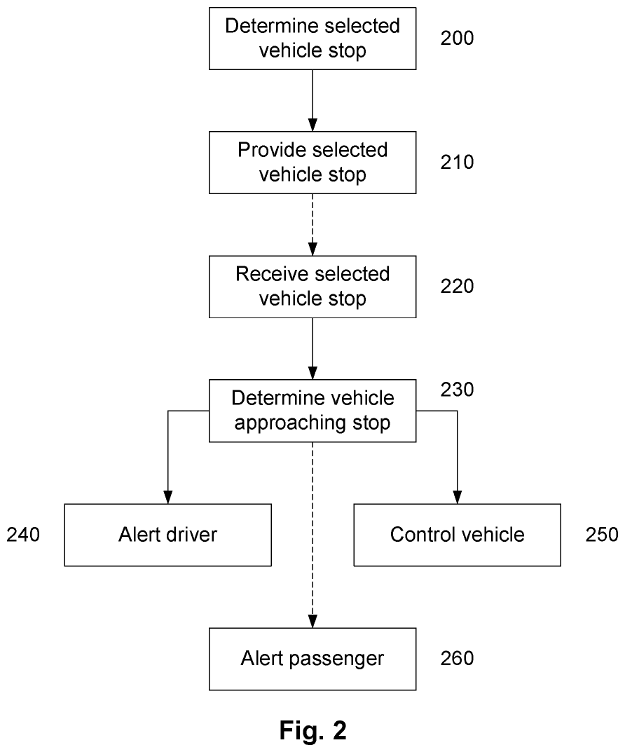

An example of the process for interacting with a vehicle will now be described with reference to FIG. 2.

In this example, at step 200 the passenger client device determines a selected vehicle stop. In this regard, the term vehicle stop is intended to refer to any location at which a vehicle stops for the purpose of allowing boarding or disembarkation of passengers, and could include bus stops, railway stations, ferry terminals, or the like, although these examples are not intended to be limiting. It should also be noted that the term should encompass permanent or temporary stops, as well as notional stops, for example where a user hails the next vehicle on a designated route of the location of the nominated stop (for rural areas and countries that do not have permanent stops). This is typically performed in accordance with user input commands, and may be achieved in a number of different ways depending on the preferred implementation.

For example, the passenger could enter details, such as a name and/or address of a particular stop, or could select a route on which they wish to travel, and then nominate a stop on the route. Alternatively, this could be achieved based on the passenger's location, for example by presenting the passenger with a list of nearby stops, allowing a passenger to select one of these.

Details of the selected vehicle stop are provided to the processing system at step 210, allowing this to be forwarded to and received by the vehicle terminal 130 at step 220.

The vehicle terminal 130 will then monitor the location of the vehicle, either by communicating with a vehicle navigation system, and/or using location sensing such as GPS or similar within the vehicle terminal 130. This allows the vehicle terminal to determine when the vehicle is approaching (including arriving at) a selected stop at step 230. When this occurs, the vehicle terminal can either generate an alert for a vehicle driver at step 240, for example to allow the vehicle driver to control the vehicle and/or selectively control at least part of the operation of the vehicle at step 250.

For example, in a manually operated vehicle a notification, such as a sound and/or visual indication, can be presented to the driver, alerting the driver to the fact that there is a passenger wanting to board and/or depart at the next stop. In one example, this can be achieved using an existing notification system, such as an onboard bell or similar, which passengers are able to activate. The alerting process makes it easy for the driver to action, avoiding them to constantly monitor to ensure passengers board and/or depart successfully, allowing them to focus on driving. Similarly, using an existing onboard notification system avoids the driver being exposed to multiple different alerts, which can again be distracting.

Additionally and/or alternatively, full or partial vehicle control can be used to assist the boarding/departing process. The nature of the control performed will vary depending on the preferred implementation and can also be adapted depending on the nature of the passenger requirements and optionally the particular stop. For example, in an automated vehicle, this could include stopping and starting the vehicle. In a manual vehicle, the control could include limiting the degree of acceleration/deceleration, for example to accommodate elderly or wheel chair passengers.

It will also be appreciated that a wide range of other types of controls could also be implemented, including, but not limited to: a door opening including duration, a door opening location, a vehicle suspension height, a vehicle stopping duration, vehicle lighting, a vehicle camera, vehicle routing parameters, vehicle air conditioning, or the like.

Additionally, at step 260, the passenger is also alerted to the fact that the vehicle is approaching the stop by the passenger client device. This can be done based on an indication provided by the vehicle terminal 130, which can be passed directly to the passenger client device 110, for example via a beacon 131, and/or could be provided to the passenger client device by the processing system 120.

In any event, it will be appreciated that the above described process allows a passenger to use a passenger client device 110 to select a stop, with this information being conveyed to a vehicle, to allow a driver to be alerted and/or the vehicle controlled, to thereby assist the passenger in successfully boarding or departing the vehicle. This makes the public transport system far easier for impaired and able bodied people to use.

A number of further features will now be described.

As mentioned above, in one example, the vehicle terminal could be configured to control various operations of the vehicle. This could be achieved automatically, for example by having the vehicle terminal generate control instructions which are provided to the vehicle control system 102, allowing the vehicle to be controlled without manual intervention. However, additionally and/or alternatively, some control operations may require manual intervention, in which case control might be achieved by alerting the driver and/or another relevant individual, such as a conductor or security personnel. For example, if a door opening duration needs to be controlled, the vehicle controller could use a timer to detect when the necessary duration has passed, and then inform the driver they may proceed with closing the door.

In one example, the vehicle terminal is configured to determine one or more passenger requirements and at least partially control the vehicle in accordance with the passenger requirements. The nature of the passenger requirements may vary, and could for example include details of impairments, such as indicating whether the passenger is partially sighted, is wheel chair bound, or has other physical limitations. In this instance, the vehicle terminal 130 will be configured to interpret the requirements and control the vehicle and/or alert the driver accordingly. Additionally and/or alternatively, the requirements could specify how the bus is controlled, for example specifying a minimum time required for the passenger to board or exit the vehicle, a need for wheelchair access, or the like.

The vehicle terminal is typically configured to determine the passenger requirements in accordance with a requirements indication from the processing system, which can in turn be determined from a passenger profile and/or an indication of passenger requirements received from the passenger client device. For example, a passenger could specify requirements each time a vehicle is requested, but more typically the passenger would establish a profile detailing requirements when the system is initially configured, for example during a sign-up process, so that requirements can be retrieved by the processing system each time the passenger uses the system to interact with a vehicle.

The requirements can also be used when selecting stops. In this regard, the process of selecting stops typically involves having the passenger client device obtain a list of available vehicle stops from the processing system, present the list of available vehicle stops to the passenger and then determine a selected stop in accordance with user input commands. Whilst stops could alternatively be stored natively on the device, retrieving the list of stops from the processing system ensures the list of stops is up to date, for example, taking into account stops that might be temporarily open or closed, and can also be used to take into account current route availability of the like, avoiding passengers being directed to a stop which is not in use and/or might not receive a vehicle for a significant amount of time.

When doing this, the processing system can be configured to determine passenger requirements and determine available vehicle stops at least in part using the one or more passenger requirements, so that only stops suitable for use by the passenger are presented as part of the list. This avoids the issue of the passenger selecting a stop they are unable to use, for example directing a wheel chair bound passenger to a stop having stair only access.

As previously mentioned, stops can also be selected based on passenger location. In this example, the passenger client device is configured to determine a passenger location and obtain a list of available vehicle stops from the processing system using the passenger location. Similarly, the processing system is configured to receive the passenger location indication from the passenger client device and determine available vehicle stops at least in part using the passenger location.

Additionally and/or alternatively, the passenger could select a particular vehicle route. For example, the passenger could select a stop and be presented with routes passing through the stop, or the passenger could select a route, with a list of available stops associated with the route. In this case, the processing system can be configured to determine vehicle routing information and provide an indication of the vehicle routing information to the passenger client device. The vehicle routing information can be of any form, but typically includes information that can help a passenger select to use the service, such as a list of stops, scheduled timing, live timing, or the like.

Once the passenger client device has obtained the vehicle routing information from the processing system, this is presented to the passenger, allowing the passenger client device to determine a selected vehicle route in accordance with user input commands. Once determined, an indication of this is sent to the processing system, so that this receives a selected vehicle route indication from the passenger client device and provides the selected vehicle stop notification to the vehicle terminal using the selected vehicle route indication. Thus, this process allows the processing system to identify a specific vehicle the passenger wishes to board, enabling the notification to be targeted at the specific vehicle, as opposed to say notifying any vehicle approaching a given stop.

As part of this process, the processing system can be configured to determine available vehicle stops at least in part using the selected vehicle route, enabling the passenger to be presented with a list of stops on a given route, which in turn can help the passenger identify a stop at which they intend to depart the vehicle.

In one example, upon a positive determination that the vehicle is approaching a selected stop, the vehicle terminal provides a vehicle approaching indication to the processing system and/or the passenger client device. In the former example, the processing system receives the vehicle approaching indication from the vehicle terminal and also provides a vehicle approaching notification to the passenger client device. This allows the passenger to be alerted when the vehicle is approaching a selected stop, allowing the passenger to know to either board or depart the vehicle as appropriate. Additionally and/or alternatively the approaching indication can be provided directly to the passenger client device from the vehicle terminal if the user is onboard, and the vehicle is approaching a stop when the passenger intends to depart.

In one example, the vehicle terminal is configured to determine passenger boarding or departing the vehicle and in response to a positive boarding or departing determination, generate an alert for a vehicle driver and/or selectively control at least part of the operation of the vehicle. This can be used to prevent doors closing and/or vehicle movement before the passenger has boarded (and optionally seated) or departed, giving the passenger time to board or depart the vehicle safely.

In this example, the passenger client device can determine passenger boarding or departing in accordance with user input commands, for example having the passenger select a boarding/departing completed option on the passenger client device. The passenger client device can provide a passenger ‘boarding complete’ or ‘departing complete’ notification to the vehicle terminal or the processing system, with in this latter case, the notification being forwarded to the vehicle terminal, allowing the driver to be alerted, or the vehicle controlled accordingly.

The above described system uses a processing system 110, a passenger client device 120 and a vehicle terminal 130, and further details of these components will now be described in further detail.

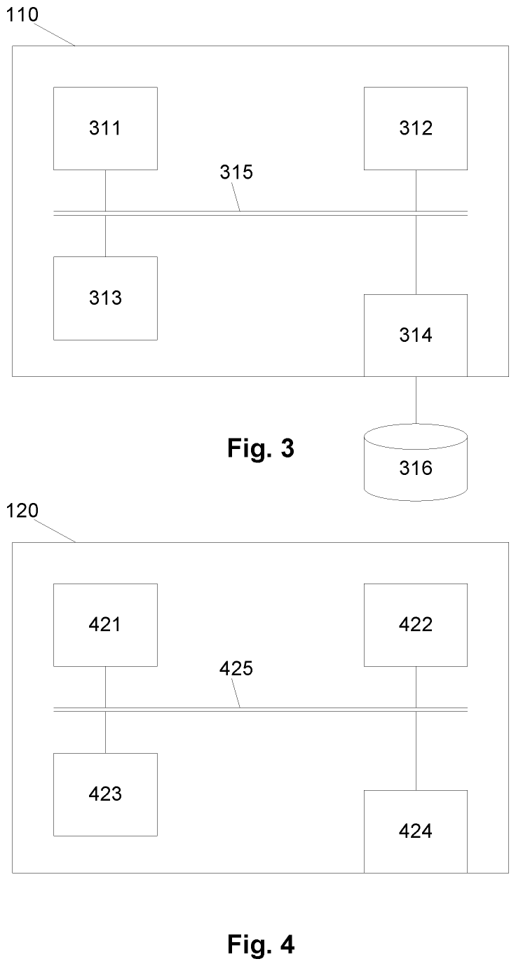

An example of a suitable processing system 110 is shown in FIG. 3.

In this example, the processing system 110 includes at least one microprocessor 311, a memory 312, an optional input/output device 313, such as a keyboard and/or display, and an external interface 314, interconnected via a busbar 315 as shown. In this example the external interface 314 can be utilised for connecting the processing system 110 to peripheral devices, such as the communications networks 140, databases 316, other storage devices, or the like. Although a single external interface 314 is shown, this is for the purpose of example only, and in practice multiple interfaces using various methods (e.g. Ethernet, serial, USB, wireless, mobile phone network, or the like) may be provided.

In use, the microprocessor 311 executes instructions in the form of applications software stored in the memory 312 to allow the required processes to be performed. The applications software may include one or more software modules, and may be executed in a suitable execution environment, such as an operating system environment, or the like.

Accordingly, it will be appreciated that the processing system 110 may be formed from any suitable processing system, and in one particular example is a server. The server might be a physical or logical server, and could be implemented on one or more physical hardware instances, meaning the server could be a cloud or edge based system. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

Furthermore, the system can use multiple processing devices and/or systems, with processing performed by one or more of the devices and/or systems as needed. However, for the purpose of ease of illustration, the following examples will refer to a single device or system, but it will be appreciated that reference to a singular processing device or system should be understood to encompass multiple processing devices or systems and vice versa, with processing being distributed between the devices or systems as appropriate.

An example of a passenger client device 120 is shown in FIG. 4.

In this example, the passenger client device 120 includes at least one microprocessor 421, a memory 422, an optional input/output device 423, such as a keyboard and/or display, and an external interface 424, interconnected via a busbar 425 as shown. In this example the external interface 424 can be utilised for connecting the passenger client device 120 to peripheral devices, such as the communications networks 140, the beacons 131, or the like. Although a single external interface 424 is shown, this is for the purpose of example only, and in practice multiple interfaces using various methods (e.g. Ethernet, serial, USB, wireless, mobile phone network, or the like) may be provided.

In use, the microprocessor 421 executes instructions in the form of applications software stored in the memory 422 to allow the required processes to be performed, as well as to allow passenger interaction for example through a suitable user interface. The applications software may include one or more software modules, and may be executed in a suitable execution environment, such as an operating system environment, or the like.

Accordingly, it will be appreciated that the passenger client device 120 may be formed from any suitable processing system, such as a suitably programmed client device, PC, Internet terminal, lap-top, or hand-held PC, and in one preferred example is either a tablet, or smart phone, or the like. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

It will also be appreciated that the client device can use multiple processing devices, with processing performed by one or more of the devices. For the purpose of ease of illustration, the following examples will refer to a single device, but it will be appreciated that reference to a singular processing device should be understood to encompass multiple processing devices and vice versa, with processing being distributed between the devices as appropriate.

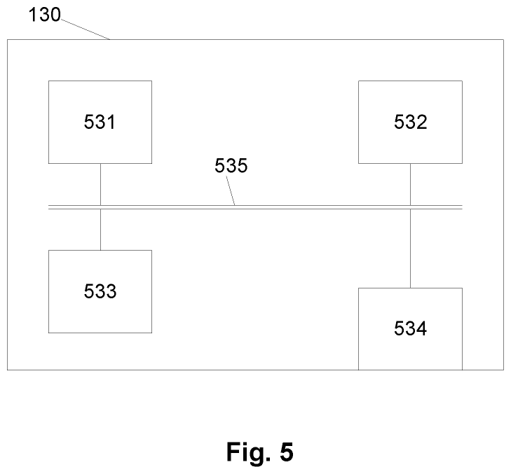

As shown in FIG. 5, in one example, the vehicle terminal 130 includes at least one microprocessor 531, a memory 532, an input/output device 533, such as a keyboard and/or display, and an external interface 534, interconnected via a busbar 535 as shown. In this example the external interface 534 can be utilised for connecting the vehicle terminal 130 to peripheral devices, such as the beacons 131, the communications networks 140, a vehicle control system 102, electronic control unit (ECU), or the like. Although a single external interface 534 is shown, this is for the purpose of example only, and in practice multiple interfaces using various methods (e.g. Ethernet, serial, USB, wireless, mobile phone network, or the like) may be provided.

In use, the microprocessor 531 executes instructions in the form of applications software stored in the memory 532 to allow required processes to be performed. The applications software may include one or more software modules, and may be executed in a suitable execution environment, such as an operating system environment, or the like.

Accordingly, it will be appreciated that the vehicle terminal 130 may be formed from any suitable processing system, such as a suitably programmed PC, or the like. However, it will also be understood that the vehicle terminal 130 can be any electronic processing device such as a microprocessor, microchip processor, logic gate configuration, firmware optionally associated with implementing logic such as an FPGA (Field Programmable Gate Array), or any other electronic device, system or arrangement.

It will also be appreciated that the vehicle terminal 130 can use multiple processing devices, with processing performed by one or more of the devices. For the purpose of ease of illustration, the following examples will refer to a single device, but it will be appreciated that reference to a singular processing device should be understood to encompass multiple processing devices and vice versa, with processing being distributed between the devices as appropriate.

For the purpose of the following examples, it is assumed that one or more processing systems 110 are servers, which communicate with the passenger client devices 120 via a communications network, or the like, depending on the particular network infrastructure available. The servers 110 typically execute applications software for performing required tasks including storing, searching and processing of data, with actions performed by the servers 110 being performed by the processor 311 in accordance with instructions stored as applications software in the memory 312 and/or input commands received from a passenger via the I/O device 312, or commands received from the passenger client device 120 and/or vehicle terminal 130.

It will also be assumed that the passenger interacts with the client device 120 via a GUI (Graphical User Interface), or the like presented on a display of the client device 120, and in one particular example via a browser application that displays webpages, or an App that displays relevant information. Actions performed by the client devices 120 are performed by the processor 421 in accordance with instructions stored as applications software in the memory 422 and/or input commands received from a passenger via the I/O device 423.

However, it will be appreciated that the above described configuration assumed for the purpose of the following examples is not essential, and numerous other configurations may be used. It will also be appreciated that the partitioning of functionality between the client devices 120, and the servers 110 may vary, depending on the particular implementation.

Further features of the above system will now be described.

In one example, the passenger client device 120 is in the form of a smartphone or similar, which is executing a commuter app that allows the passenger to view the stations nearby, plan a trip, and hail a vehicle, with the app further communicating with the vehicle operator and vehicle itself. However, it will be appreciated that the hailing and vehicle communication functions can also be replicated using physical terminals at each station or stop.

The processing systems 110 can be in the form of servers that act as the main communication point for all of the other components of the system, including the commuter app, station terminals, a public transport infrastructure and the vehicle terminals. To add to the aforementioned task, the servers 110 can also serve as a city's main public transport infrastructure if one does not already exists.

The vehicle control terminal 130 can have three main modes of operation, and relies on the information provided by the server 110 and vehicle location data to operate. The three main modes of operation are:
Alert only mode.
Fully automated mode.
Hybrid mode.

The alert only mode, is used when the public transport vehicles are operated by a person. So, the vehicle control terminal only displays pickup and drop-off alerts. The alerts are only displayed one station before the vehicle operator needs to stop: to minimise distractions. This mode can provide the vehicle operator the number of commuters that need to be picked up, dropped off, whether they are in a wheel chair and other information, but it does not directly interact with the vehicle.

The fully automated mode of operation, interacts with the vehicle directly, typically by sending control instructions to a vehicle control system 102, and can control functions such as:
Suspension/vehicle height.
Vehicle velocity and acceleration.
Route parameter deviations if necessary.
Vehicle lights, HVAC and cameras.
Doors.

Through the automated mode, the vehicle control terminal can adjust various parameters to not only ensure that commuters are not left behind, but to also compensate in advance for time fluctuations caused by:
The number of passengers that need to be picked up and dropped off per stop.
The acceleration parameters depending on whether people in wheel chairs are onboard.
Light, HVAC and camera controls depending on time, temperature and past, present and future occupancy states and on-board activity.

In respect of this latter point, a passenger may select an ‘alert security’ button on their device if they do not feel safe—and this could trigger onboard cameras, and simultaneously alert remote monitoring security operator, to thereby provide additional safety for passengers.

The vehicle control terminal is also able to operate in a hybrid mode, which provides flexibility for transport agencies with their vehicle and worker deployments.

Last, but not least, optional LE Bluetooth beacons can be installed on vehicles with the vehicle control terminal and/or stops, which can assist passengers in accurately locating stops or vehicles. The primary function of the beacons is: to negate any latency caused by the 3G, 4G and 5G networks that connect the commuter's phone, servers and vehicle control terminals. This is to ensure that drop-off alerts can be sent to a commuter's phone at the appropriate time: not too early, and not too late.

The system is capable of operating in two ways, namely in conjunction with a city's public transport infrastructure, or as a standalone public transport system. Further details of both forms of operation will now be described.

When used in conjunction with an existing public transport system the system uses information from the existing system for its operation. This data is generally transmitted using protocols such as: GTFS, GTFS Real Time, HTTP or HTTPS. The data that most existing system provide can be divided into two main categories, namely static and dynamic data.

The static data contains bus, shuttle, train, metro, tram, and light rail stops and station locations. Furthermore, it also contains the static timetables for that public transport system services. The static data is generally updated only every 3 months.

The dynamic data in the other hand, is only available if the public transport system in question has the ability to track vehicles in real time. If dynamic data is available, this data transmits vehicle locations, estimated arrival times and vehicle speed, with updates occurring every 15 to 30 seconds. However, this is dependent on the city in question.

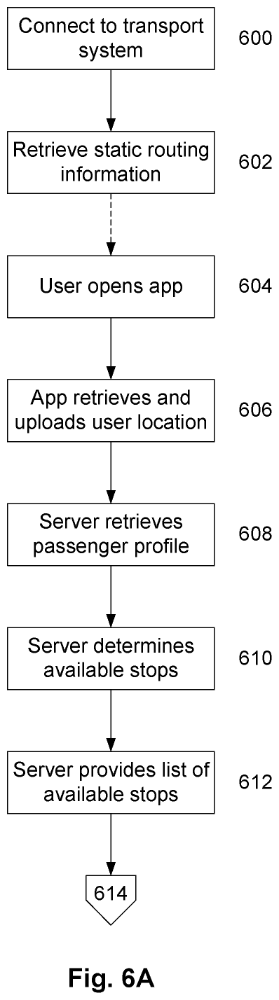

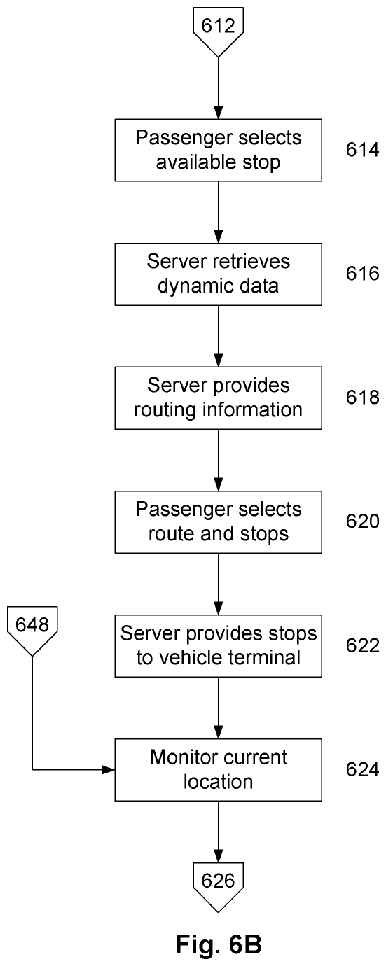

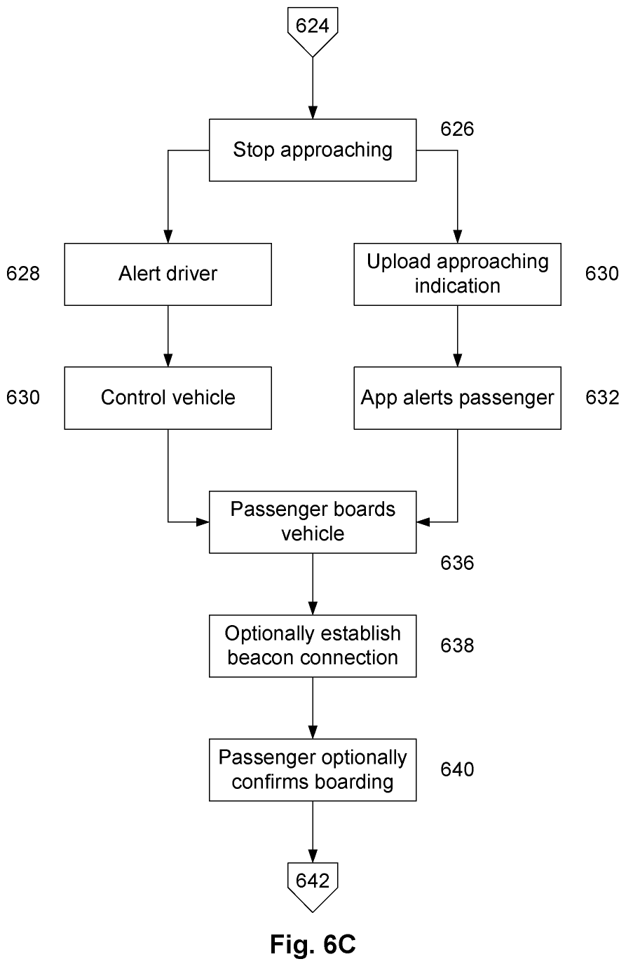

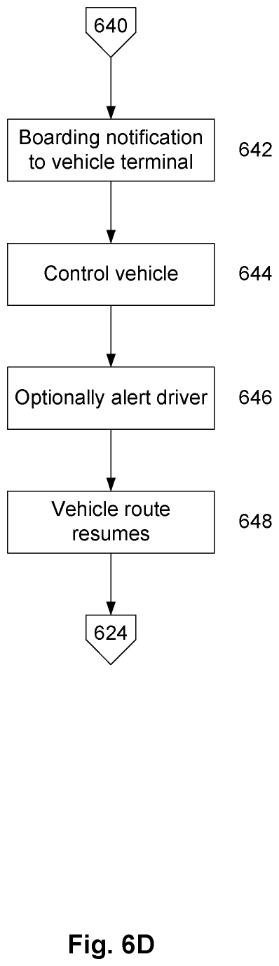

A specific example interaction allowing a passenger to take a journey on public transport will now be described with reference to FIGS. 6A to 6D.

In this example, the servers 110 establish a connection with the transport system servers at step 600, allowing static routing information to be retrieved at step 602. It will be appreciated that this is a one off process that only needs to be performed at the beginning of the deployment, and does not need to be repeated each time a journey is performed.

When a passenger wants to commence a journey, the passenger opens the commuter app on the passenger client device 120 at step 604, with the app retrieving GPS coordinates of the passenger and uploading these to the servers 110 at step 606. At step 608, the server 110 optionally retrieves a passenger profile for the passenger, including details of any specified passenger requirements, such as limitations on the types of stops the passenger is able or unable to use, although it will be appreciated that alternatively, this could be entered manually by the passenger each time a vehicle is ordered, for example in the event that the passenger has changing requirements.

The server 110 determines available stops, based on the passenger location and optionally taking into account the passenger requirements, at step 610. For example, this could include retrieving the 50 stops that are closest to the passenger, with the list of available stops being sent to the client device 120 at step 612.

At step 614, the passenger selects their desired stop, with this being submitted to the server 110, allowing the server to retrieve dynamic data (if available) at step 616, and then provide routing information associated with the stop at step 618. In particular, this will include static routing information for that station, including details of the different routes that service the stops, and the scheduled time of vehicles, together with any live timing data if available. To simplify this, the information presented to the passenger could include the different routes and the time of the next vehicle on each route, but with the option of allowing the passenger to specify different times, for example allowing the passenger to view vehicles that are scheduled for a later time.

The passenger selects the desired route and optionally a departure stop on the route at step 620, although a departure stop could for example be selected later, after boarding, or the like. Details of the selected route and any selected departure stop is uploaded to the server 110, allowing the server 110 to forward details of the boarding and departure stop to the vehicle terminal 130 at step 622. The information sent to the vehicle terminal may also include any requirements associated with the passenger, as retrieved from the passenger profile at step 608.

At step 624, the vehicle terminal 130 monitors the current location of the vehicle, either using an internal sensing system within the vehicle terminal 130, or by receiving this information from a positioning sensing system associated with the vehicle. It will be appreciated that in one example, this could be achieved by using dynamic data that is uploaded from the vehicle to the transport system servers, in which case the vehicle terminal may simply receive the data that is uploaded, or alternatively may receive this indirectly from the server 120.

The vehicle terminal 130 maintains a list of selected boarding and departure stops and compares the current vehicle location to the intended vehicle route and stop locations to identify when a selected stop is being approached at step 626, for example determining when the vehicle is at or leaving an immediately preceding stop. At this point, the vehicle terminal 130 will alert the driver at step 628 and/or control the vehicle at step 630. Thus, for example, the vehicle terminal could alert the driver to stop at the next stop, regardless of whether or not they are hailed by someone wishing to board, and then as the stop is approached, control the vehicle, for example controlling acceleration/deceleration parameters, controlling the door opening and/or raising or lowering the vehicle suspension. This is typically performed based on the passenger requirements and is achieved by having the vehicle terminal send control instructions to a vehicle control system 102.

Simultaneously the vehicle terminal 130 provides an approaching indication to the passenger client device 120. If the passenger is boarding this will be achieved by uploading the approaching indication to the server 110, which then notifies the passenger client device 120, so that the app on the passenger client device 120 alerts the passenger at step 632, ensuring the passenger knows to board as needed. It will be noted that if the passenger is departing, a similar process is performed, but that this can additionally and/or alternatively be achieved by having the vehicle terminal forward the indication directly, or by using one of the beacons 131.

At step 636, the passenger boards the vehicle. This process might be facilitated by additional technologies integrated into the system. For example, a passenger may need to be guided to the vehicle, which can be particularly problematic if there are multiple vehicles present at a stop. In one example, the passenger client device can employ Ultra Wideband or other similar technologies, in order to identify the correct vehicle and/or doors, for boarding. In this case, the user could point their phone at the vehicles that have arrived, and given that the technology is directional, the phone would notify the user of the number of the vehicle that they are pointing their phone at, and it's distance from them, guiding the user to board the correct vehicle. Once boarding has occurred, a connection can be established with a beacon 131 at step 638, allowing the passenger client device to communicate with the vehicle terminal 130 and/or server 110.

At step 640, the passenger may be required to confirm they have boarded, although this could additionally and/or alternatively be monitored by the bus, for example using on-board cameras to detect if the passenger has boarded and sat down. At this point a boarding notification can be provided to a vehicle terminal at step 642, either directly via the beacon 131, or via the server 110, allowing the vehicle to be controlled, for example to close the doors at step 644. The driver may also be alerted at step 646, allowing the route to resume at step 648. It will then be appreciated the process returns to step 624 to allow the vehicle position to be monitored to identify further stops, such as the departing stop for the passenger.

In the above process, if beacons 131 are present, the vehicle is used as the source for location data and the data is sent directly to the passenger client device, which increases the accuracy for location data and timing for the alerts. If the beacons are not present, the system will rely on the various networks that connect the passenger client device and the vehicle terminal to send the alerts. A passenger client device may also be used for location data to minimise any latency caused by the connecting networks.

It will be appreciated that if no existing transport system is available, the above described arrangement can achieve similar functionality by monitoring vehicle locations using the vehicle terminals and using that to generate the dynamic data.

Accordingly, the above described system can facilitate interaction with a public transport system, particularly assisting with hailing, boarding, riding and/or departing a vehicle. It will be appreciated from this that the term interaction should encompass boarding and/or departing from a vehicle. However, other interactions could also be facilitated by the above described arrangement. For example, a user might be able to access and/or trigger security features in the event that they feel unsafe or threatened, for example to activate cameras onboard a vehicle, to summon assistance, initiate an emergency stop, or similar, and that these processes could be performed using a broadly similar process, with the notification transferred from the passenger device to the processing system and/or vehicle terminal being adjusted as needed.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A vehicle interaction system to allow passenger interaction with a public transport vehicle, the system including:
a) a processing system;
b) a passenger client device configured to:
i) determine a selected vehicle stop in accordance with user input commands;
ii) provide a selected vehicle stop to the processing system; and,
iii) notify the passenger when the vehicle is approaching the selected vehicle stop; and,
c) a vehicle terminal configured to:
i) receive a selected vehicle stop notification from the processing system;
ii) determine when the vehicle is approaching the selected stop by monitoring a current vehicle location; and,
iii) in response to a positive determination, selectively control at least part of the operation of the vehicle.

2. A system according to claim 1, wherein the vehicle terminal is configured to control at least one:
a) a door opening duration, or opening/closing instruction to the door;
b) a door opening location;
c) a vehicle suspension height;
d) a vehicle acceleration;
e) a vehicle deceleration;
f) a vehicle velocity;
g) a vehicle stopping duration;
h) a vehicle stopping location;
i) vehicle lighting;
j) vehicle camera;
k) vehicle routing parameters; and,
l) vehicle air conditioning.

3. A system according to claim 1 or claim 2, wherein the vehicle terminal is configured to:
a) determine one or more passenger requirements; and
b) at least partially control the vehicle in accordance with the passenger requirements.

4. A system according to claim 3, wherein the vehicle terminal is configured to determine the passenger requirements in accordance with a requirements indication from the processing system.

5. A system according to any one of the claims 1 to 4, wherein the passenger client device is configured to:
a) obtain a list of available vehicle stops from the processing system:
b) present the list of available vehicle stops to the passenger; and,
c) determine a selected stop in accordance with user input commands.

6. A system according to claim 5, wherein the processing system is configured to:
a) determine one or more passenger requirements; and,
b) determine available vehicle stops at least in part using the one or more passenger requirements.

7. A system according to claim 4 or claim 6, wherein the processing system is configured to determine one or more passenger requirements based on at least one of:
a) a passenger profile; and,
b) an indication of passenger requirements received from the passenger client device.

8. A system according to any one of the claims 1 to 7, wherein the passenger client device is configured to:
a) determine a passenger location; and,
b) obtain a list of available vehicle stops from the processing system using the passenger location.

9. A system according to claim 8, wherein the processing system is configured to:
a) receive a passenger location indication from the passenger client device; and,
b) determine available vehicle stops at least in part using the passenger location.

10. A system according to any one of the claims 1 to 9, wherein the processing system is configured to:
a) determine vehicle routing information; and,
b) provide an indication of the vehicle routing information to the passenger client device.

11. A system according to claim 10, wherein the passenger client device is configured to:
a) obtain vehicle routing information from the processing system:
b) present vehicle routing information to the passenger; and,
c) determine a selected vehicle route in accordance with user input commands.

12. A system according to any one of the claims 1 to 11, wherein the processing system is configured to:
a) receive a selected vehicle route indication from the passenger client device; and,
b) provide the selected vehicle stop notification to the vehicle terminal using the selected vehicle route indication.

13. A system according to any one of the claims 1 to 12, wherein the processing system is configured to:
a) receive a selected vehicle route indication from the passenger client device; and,
b) determine available vehicle stops at least in part using the selected vehicle route.

14. A system according to any one of the claims 1 to 13, wherein, in response to a positive determination, the vehicle terminal is configured to provide a vehicle approaching indication to at least one of:
a) the processing system; and,
b) the passenger client device.

15. A system according to any one of the claims 1 to 14, wherein the processing system is configured to:
a) receive a vehicle approaching indication from the vehicle terminal when the vehicle is approaching a selected stop; and,
b) provide a vehicle approaching notification to the passenger client device.

16. A system according to any one of the claims 1 to 15, wherein the vehicle terminal is configured to:
a) determine if a passenger is or has completed boarding or departing the vehicle; and,
b) in response to a positive boarding or departing determination, at least one of:
i) generate an alert for a vehicle driver; and,
ii) selectively control at least part of the operation of the vehicle.

17. A system according to any one of the claims 1 to 16, wherein the passenger client device is configured to:
a) determine if a passenger is or has completed boarding or departing in accordance with user input commands; and,
b) provide a passenger boarding or departing notification to at least one of:
i) the vehicle terminal; and,
ii) the processing system.

18. A system according to any one of the claims 1 to 17, wherein the system includes vehicle beacons and wherein the passenger client device is configured to communicate using the vehicle beacons with at least one of:
a) the processing system; and,
b) the vehicle terminal.

19. A system according to any one of the claims 1 to 18, wherein the selected stop is at least one of:
a) a boarding stop; and,
b) a destination stop.

20. A system according to any one of the claims 1 to 19, wherein the vehicle terminal is configured to control at least part of the operation of the vehicle by sending control instructions to a vehicle control system.

21. A vehicle interaction method to allow passenger interaction with a public transport vehicle, the method including:
a) in a passenger client device:
i) determining a selected vehicle stop in accordance with user input commands:
ii) providing a selected vehicle stop to a processing system; and,
iii) notifying the passenger when the vehicle is approaching the selected vehicle stop; and,
b) in a vehicle terminal:
i) receiving a selected vehicle stop notification from the processing system:
ii) determining when the vehicle is approaching the selected stop by monitoring a current vehicle location; and,
iii) in response to a positive determination selectively controlling at least part of the operation of the vehicle.

22. A vehicle interaction system to allow passenger interaction with a public transport vehicle, the system including:
a) a processing system:
b) a passenger client device configured to:
i) determine a selected vehicle stop in accordance with user input commands:
ii) provide a selected vehicle stop to the processing system; and,
iii) notify the passenger when the vehicle is approaching the selected vehicle stop; and,
c) a vehicle terminal configured to:
i) receive a selected vehicle stop notification from the processing system;
ii) determine when the vehicle is approaching the selected stop by monitoring a current vehicle location; and,
iii) in response to a positive determination, generate an alert for a vehicle driver.

23. A system according to claim 22, wherein the vehicle terminal is configured to control at least one:
a) a door opening duration, or opening/closing instruction to the door;
b) a door opening location;
c) a vehicle suspension height;
d) a vehicle acceleration;
e) a vehicle deceleration;
f) a vehicle velocity;
g) a vehicle stopping duration;
h) a vehicle stopping location;
i) vehicle lighting;
j) vehicle camera;
k) vehicle routing parameters; and,
l) vehicle air conditioning.

24. A system according to claim 22 or claim 23, wherein the vehicle terminal is configured to:
a) determine one or more passenger requirements; and
b) at least partially control the vehicle in accordance with the passenger requirements.

25. A system according to claim 24, wherein the vehicle terminal is configured to determine the passenger requirements in accordance with a requirements indication from the processing system.

26. A system according to any one of the claims 22 to 25, wherein the passenger client device is configured to:
a) obtain a list of available vehicle stops from the processing system;
b) present the list of available vehicle stops to the passenger; and,
c) determine a selected stop in accordance with user input commands.

27. A system according to claim 26, wherein the processing system is configured to:
a) determine one or more passenger requirements; and,
b) determine available vehicle stops at least in part using the one or more passenger requirements.

28. A system according to claim 25 or claim 27, wherein the processing system is configured to determine one or more passenger requirements based on at least one of:
a) a passenger profile; and,
b) an indication of passenger requirements received from the passenger client device.

29. A system according to any one of the claims 22 to 28, wherein the passenger client device is configured to:
a) determine a passenger location; and,
b) obtain a list of available vehicle stops from the processing system using the passenger location.

30. A system according to claim 29, wherein the processing system is configured to:
a) receive a passenger location indication from the passenger client device; and,
b) determine available vehicle stops at least in part using the passenger location.

31. A system according to any one of the claims 22 to 30, wherein the processing system is configured to:
a) determine vehicle routing information; and,
b) provide an indication of the vehicle routing information to the passenger client device.

32. A system according to claim 31, wherein the passenger client device is configured to:
a) obtain vehicle routing information from the processing system;
b) present vehicle routing information to the passenger; and,
c) determine a selected vehicle route in accordance with user input commands.

33. A system according to any one of the claims 22 to 32, wherein the processing system is configured to:
a) receive a selected vehicle route indication from the passenger client device; and,
b) provide the selected vehicle stop notification to the vehicle terminal using the selected vehicle route indication.

34. A system according to any one of the claims 22 to 33, wherein the processing system is configured to:
a) receive a selected vehicle route indication from the passenger client device; and,
b) determine available vehicle stops at least in part using the selected vehicle route.

35. A system according to any one of the claims 22 to 34, wherein, in response to a positive determination, the vehicle terminal is configured to provide a vehicle approaching indication to at least one of:
a) the processing system; and,
b) the passenger client device.

36. A system according to any one of the claims 22 to 35, wherein the processing system is configured to:
a) receive a vehicle approaching indication from the vehicle terminal when the vehicle is approaching a selected stop; and,
b) provide a vehicle approaching notification to the passenger client device.

37. A system according to any one of the claims 22 to 36, wherein the vehicle terminal is configured to:
a) determine if a passenger is or has completed boarding or departing the vehicle; and,
b) in response to a positive boarding or departing determination, at least one of:
i) generate an alert for a vehicle driver; and,
ii) selectively control at least part of the operation of the vehicle.

38. A system according to any one of the claims 22 to 37, wherein the passenger client device is configured to:
a) determine if a passenger is or has completed boarding or departing in accordance with user input commands; and,
b) provide a passenger boarding or departing notification to at least one of:
i) the vehicle terminal; and,
ii) the processing system.

39. A system according to any one of the claims 22 to 38, wherein the system includes vehicle beacons and wherein the passenger client device is configured to communicate using the vehicle beacons with at least one of:
a) the processing system; and,
b) the vehicle terminal.

40. A system according to any one of the claims 22 to 39, wherein the selected stop is at least one of:
a) a boarding stop; and,
b) a destination stop.

41. A system according to any one of the claims 22 to 40, wherein the vehicle terminal is configured to control at least part of the operation of the vehicle by sending control instructions to a vehicle control system.

42. A vehicle interaction method to allow passenger interaction with a public transport vehicle, the method including:
a) in a passenger client device:
i) determining a selected vehicle stop in accordance with user input commands;
ii) providing a selected vehicle stop to a processing system; and,
iii) notifying the passenger when the vehicle is approaching the selected vehicle stop;
b) in a vehicle terminal:
i) receiving a selected vehicle stop notification from the processing system;
ii) determining when the vehicle is approaching the selected stop by monitoring a current vehicle location; and,
iii) in response to a positive determination, generating an alert for a vehicle driver.
